(19) United States
(12) Patent Application Publication
(10) Pub. No.: US 2003/0001731 A1
(43) Pub. Date: Jan. 2, 2003

(54) Third brake inner indicating light device

(76) Inventor: Tsang-Ming Tsai, Taipei (TW)

Correspondence Address: BACON & THOMAS, PLLC, 625 SLATERS LANE, FOURTH FLOOR, ALEXANDRIA, VA, 22314

(21) Appl. No.: 09/879,907

(22) Filed: Jun. 14, 2001

(51) Int. Cl. B60Q 1/00

(52) U.S. Cl. 340/435; 340/479; 340/464

(57) ABSTRACT

The present invention relates to a third brake inner indicating light device, especially one indicating distance of rear objects while backing a car. The present invention mainly comprises a third brake light, a projector and a receiver. The third brake light is connected to the receiver and is designed with an indicating screen at the back. The projector is found at the top of the bumper and connected to the receiver such that a short range electric wave is emitted while backing a car. The receiver is found inside the baggage compartment, is separately connected to the third brake light and the projector and warms the driver of any rear obstacles by means of letters, signals or diagrams after receiving signal from the projector. The present invention hence increases backing car safely.

### TECHNICAL RANGE

The present invention relates to a third brake inner indicating light device, especially one indicating distance of rear objects while backing a car.

### INVENTION BACKGROUND

Commonly used third brake lights are found at the back of a car and are usually activated when applying the brakes. The third brake light is generally found at the back window screen and the back shell can be clearly seen while backing a car. It is therefore an object of the present invention to provide a safer environment by adding an indicating screen at the back shell of the third brake light.

The rear lights as well as the third brake light are usually illuminated while a car is backing. Hence, it would be much safer if a car radar could be added to warm the driver of road conditions within a limited range by using an indicating screen designed at the back shell of the third brake light.

It is generally quite difficult to back a car at night or during bad weather conditions and dangerous if there are any infants or lifeless objects on the way. Further, the backing sound signal should be eliminated as it is sometimes even more dangerous and very noisy.

### SUMMARY OF INVENTION

According to the present invention of a third brake inner indicating light device, an indicating screen is designed to warm the driver of rear objects or distance while backing a car by means of letters, signals or diagrams.

According to the present invention of a third brake inner indicating light device, a projector and a receiver are connected to the third brake light. The projector is activated while backing a car and emits a short range electric-wave such that a reaction wave of any rear objects will be received by the receiver and projected in the third brake inner indicating screen.

### DESCRIPTION OF DIAGRAM

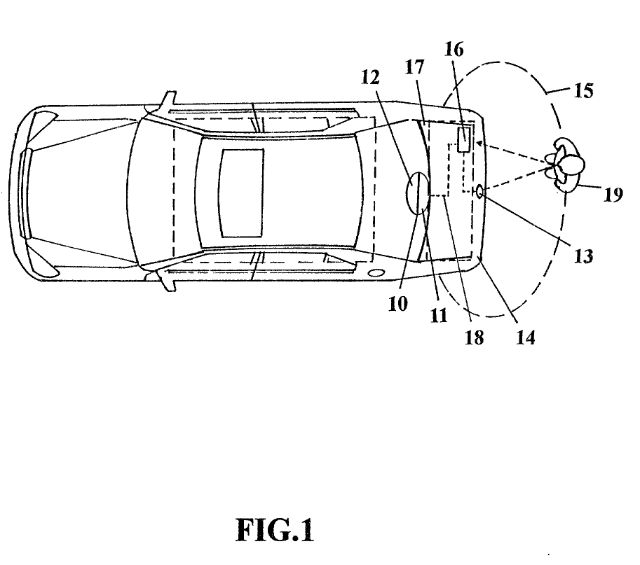

FIG. 1 shows the present invention in use.

NUMERICAL

| | |
|---|---|
| 10-third brake light | 11-lighting screen |
| 12-inner indicating screen | 13-projector |
| 14-rear bumper | 15-short range electric-wave |
| 16-receiver | 17-baggage compartment |
| 18-wire | 19-object |

### MODE FOR CARRYING OUT INVENTION

With reference to FIG. 1 showing the present invention in use, the third brake light comprises of a lighting screen 11 at the outer indicating screen and an inner indicating screen inside the car.

With further reference to FIG. 1, the projector 13 is found at the top of the bumper 14 and emits a short range electric-wave 15 while backing a car. The receiver 16 is found inside the baggage compartment 17 and is connected by means of a wire 18 to the third brake light 10. If there is a reaction of the short range electric-wave 15 of any reaction wave and warms the driver by means of letters, signals or diagrams projected in the inner indicating screen 12.

1. A third brake inner indicating light mainly comprising a third brake light, a projector and a receiver wherein:
The third brake light is connected to the receiver and designed with an inner indicator at the back;
The projector is found at the top of the bumper and connected to the receiver such that a short range electric-wave is emitted while backing a car;
The receiver, designed with a micro-computer is found at the baggage compartment and is separately connected to the third brake light and the projector and warms the driver when receiving any reaction wave by means of letters, signals or diagrams projected in the inner indicating screen.
